(19) United States
(12) Patent Application Publication
(10) Pub. No.: US 2009/0326901 A1
(43) Pub. Date: Dec. 31, 2009

(54) APPARATUS AND METHOD FOR ESTIMATING CHANGE AMOUNT IN REGISTER TRANSFER LEVEL STRUCTURE AND COMPUTER-READABLE RECORDING MEDIUM

(75) Inventor: Yohei Kojima, Chiba-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/490,637

(22) Filed: Jun. 24, 2009

(30) Foreign Application Priority Data
Jun. 25, 2008 (JP) 2008-165845
May 13, 2009 (JP) 2009-116494

(51) Int. Cl. G06F 17/50

(52) U.S. Cl. 703/14

(57) ABSTRACT

An apparatus for estimating a change amount in a register transfer level structure includes: a correspondence relationship creating unit which describes a correspondence relationship among a behavioral description, a control data flow graph, and a register transfer level structure of a register transfer level description created by performing high-level synthesis on the behavioral description, based on the behavioral description which is input, the control data flow graph which is input and created by performing high-level synthesis on the behavioral description, and binding information which is input and created by performing high-level synthesis on the behavioral description; and a register transfer level change amount estimating unit which estimates and outputs a change amount in the register transfer level structure, the change amount in the register transfer level structure being necessary to change the register transfer level description to a description equivalent to a partially changed behavioral description, based on information of the partially changed behavioral description obtained by partially changing the behavioral description and the created correspondence relationship.

### CROSS REFERENCE TO RELATED APPLICATIONS

This application is based upon and claims the benefit of priority from the prior Japanese Patent Application No. 2008-165845 filed on Jun. 25, 2008 and No. 2009-116494 filed on May 13, 2009, the entire contents of which are incorporated herein by reference.

### BACKGROUND OF THE INVENTION

1. Field of the Invention

The present invention relates to an apparatus and method for estimating a change amount in a register transfer level structure and to a computer-readable recording medium.

2. Related Art

In a design flow using high-level synthesis, in place of a register transfer level (hereinbelow, abbreviated as RTL) description which is conventionally manually created, an RTL description which is obtained by performing high-level synthesis on a behavioral description created using the C language or SystemC language. Essentially, after sufficiently verifying the behavioral description, a program has to advance to the next step in the design flow. However, there is a case that, after a program advances to a lower process with insufficient verification, a bug is found in behavioral description. In this case, when a high-level synthesis is performed again after the bug in the behavioral description is corrected, even a small change in the behavioral description, a large change may occur in a portion other than the changed portion in the RTL description which is output. Due to this, large backslide occurs in the lower process.

In the conventional RTL design, when correction of an RTL description becomes necessary in a stage of the lower process, the backslide is reduced by correcting only a change portion by ECO (Engineering Change Order) of performing correction equivalent to the correction on the RTL description onto a gate net list. Consequently, a method of shortening the backslide time is considered in which, in a manner similar to the above, the ECO in the RTL description, that is, a correction equivalent to the correction on the behavioral description is performed also in a design flow using the high-level synthesis.

However, since a functional unit is shared and a bit width is optimized in the high-level synthesized RTL description, the behavioral description and the RTL description are not easily associated with each other, and it is difficult to perform analysis by a person. A method of easily making behavioral description and RTL description associated with each other is known (refer to Japanese Patent Application Laid-Open No. 2006-285865). However, even if a correspondence is known by using the method, the scale of an RTL description change cannot be known due to the influence of optimization of the bit width and the like until a correction is actually made. Consequently, it is determined that the change is not a change of a scale at which the ECO can be performed in a lower process only after the RTL description is corrected.

There is also known a method of automatically correcting an RTL description by merging an RTL description obtained by performing the high-level synthesis only in a change part in a behavioral description with an RTL description before the change (refer to Japanese Patent Application Laid-Open No. 2007-34584). In the method, however, only addition of a functional unit is considered as the correction method, and a change in the bit width and the like is not also considered, so that a large amount of a change in an RTL description to be corrected, inaccuracy, and the like become an issue. As a result of redundant increase in the change amount in the RTL description corrected, there is the possibility that the change becomes a change of a scale at which the ECO cannot be performed.

### SUMMARY OF THE INVENTION

In accordance with one embodiment of the present invention, there is provided an apparatus for estimating a change amount in a register transfer level structure, comprising: a correspondence relationship creating unit which describes a correspondence relationship among a behavioral description, a control data flow graph, and a register transfer level structure of a register transfer level description created by performing high-level synthesis on the behavioral description, based on the behavioral description which is input, the control data flow graph which is input and created by performing high-level synthesis on the behavioral description, and binding information which is input and created by performing high-level synthesis on the behavioral description; and a register transfer level change amount estimating unit which estimates and outputs a change amount in the register transfer level structure, the change amount in the register transfer level structure being necessary to change the register transfer level description to a description equivalent to a partially changed behavioral description, based on information of the partially changed behavioral description obtained by partially changing the behavioral description and the created correspondence relationship.

Moreover, in accordance with another embodiment of the present invention, there is provided a method for estimating a change amount in a register transfer level structure, comprising: describing a correspondence relationship among a behavioral description, a control data flow graph, and a register transfer level structure of a register transfer level description created by performing high-level synthesis on the behavioral description, based on the behavioral description which is input, the control data flow graph which is input and created by performing high-level synthesis on the behavioral description, and binding information which is input and created by performing high-level synthesis on the behavioral description by a correspondence relationship creating unit; and estimating and outputting a change amount in the register transfer level structure, the change amount in the register transfer level structure being necessary to change the register transfer level description to a description equivalent to a partially changed behavioral description, based on information of the partially changed behavioral description obtained by partially changing the behavioral description and the created correspondence relationship by a register transfer level change amount estimating unit.

In addition, in accordance with a further embodiment of the present invention, there is provided a computer-readable recording medium storing a computer program for making a computer execute an estimation of a change amount in a register transfer level structure, wherein the computer program makes the computer describe a correspondence relationship among a behavioral description, a control data flow graph, and a register transfer level structure of a register transfer level description created by performing high-level synthesis on the behavioral description, based on the behavioral description which is input, the control data flow graph which is input and created by performing high-level synthesis on the behavioral description, and binding information which is input and created by performing high-level synthesis on the behavioral description and estimate and output a change amount in the register transfer level structure, the change amount in the register transfer level structure being necessary to change the register transfer level description to a description equivalent to a partially changed behavioral description, based on information of the partially changed behavioral description obtained by partially changing the behavioral description and the created correspondence relationship.

### BRIEF DESCRIPTION OF THE DRAWINGS

FIG. 1 is a block diagram of an RTL structure change amount estimating apparatus as a first embodiment of the present invention;

FIG. 2 is a hardware configuration diagram of the RTL structure change amount estimating apparatus as the first embodiment of the invention;

FIG. 3 shows an example of a behavioral description and a change in the behavioral description in the first embodiment of the invention;

FIG. 4 shows a CDFG corresponding to the example of FIG. 3;

FIG. 5 shows correspondence relationships of the behavioral description, CDFG, and RTL structure in the example of FIG. 3;

FIG. 6 shows functional unit/register sharing information in the example of FIG. 3;

FIG. 7 shows operation result sharing information in the example of FIG. 3;

FIG. 8 shows a CDFG after a change in the example of FIG. 3;

FIG. 9 shows a result of estimation of the change amount in the RTL structure in the example of FIG. 3;

FIG. 10 shows an example of a behavioral description and a change in the behavioral description in a second embodiment of the invention;

FIG. 11 shows a CDFG corresponding to the example of FIG. 10;

FIG. 12 shows correspondence relationships of the behavioral description, CDFG, and RTL structure in the example of FIG. 10;

FIG. 13 shows functional unit/register sharing information in the example of FIG. 10;

FIG. 14 shows a CDFG after a change in the example of FIG. 10;

FIG. 15 shows a result of estimation of the change amount in the RTL structure in the example of FIG. 10;

FIG. 16 shows an example of a behavioral description and a change in the behavioral description in a third embodiment of the invention;

FIG. 17 shows a CDFG corresponding to the example of FIG. 16;

FIG. 18 shows correspondence relationships of the behavioral description, CDFG, and RTL structure in the example of FIG. 16;

FIG. 19 shows functional unit/register sharing information in the example of FIG. 16;

FIG. 20 shows bit width information of a component in the example of FIG. 16;

FIG. 21 shows information of components whose bit width has to be changed in the example of FIG. 16;

FIG. 22 shows a CDFG after a change in the example of FIG. 16;

FIG. 23 shows a result of estimation of the change amount in the RTL structure in the example of FIG. 16;

FIG. 24 is a block diagram of an RTL change amount estimating apparatus as a fourth embodiment of the present invention;

FIG. 25 shows an example of a behavioral description and a change in the behavioral description in a fourth embodiment of the invention;

FIG. 26 shows a scheduling result obtained by performing high-level synthesis on the behavioral descriptions in FIG. 25;

FIG. 27 is a flowchart in a scheduling change unit in the fourth embodiment of the invention;

FIGS. 28A and 28B show examples of the CDFG in the case where the operation can be set in a preceding cycle in the fourth embodiment of the invention; and

FIG. 29 shows an example of the CDFG in the case where the operation cannot be set in a preceding cycle in the fourth embodiment of the invention.

### DETAILED DESCRIPTION OF THE INVENTION

Embodiments of the present invention will be described below with reference to the drawings. The present invention is not limited by the embodiments.

### First Embodiment

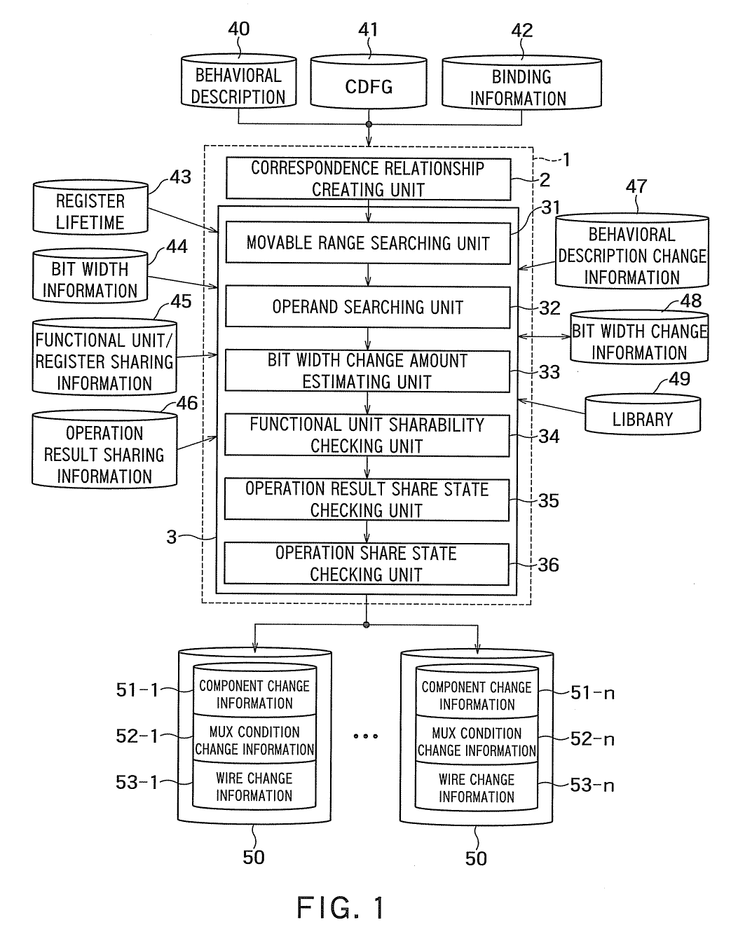

A first embodiment of the present invention will be described with reference to FIGS. 1 to 9.

FIG. 1 is a block diagram showing a general configuration of an RTL structure change amount estimating apparatus as the first embodiment of the present invention. An RTL structure change amount estimating apparatus 1 has a correspondence relationship creating unit 2 and an RTL change amount estimating unit 3. The RTL change amount estimating unit 3 has, as sub blocks, a movable range searching unit 31, an operand searching unit 32, a bit width change amount estimating unit 33, a functional unit sharability checking unit 34, a operation result share state checking unit 35, and a operation share state checking unit 36.

From a behavioral description 40, a control data flow graph 41 (hereinbelow, abbreviated as CDFG), and functional unit binding information 42 which are input, the correspondence relationship creating unit 2 creates a correspondence relationship between a line number of the behavioral description 40, expression of the behavioral description 40, expression of the CDFG 41 and allocation of an RTL structure. The CDFG 41 and the functional unit binding information 42 are obtained by performing high-level synthesis on the behavioral description 40. The RTL structure expresses a logic circuit described in the RTL description. The functional unit binding information 42 expresses allocation of an operation, a register, or an operand in the CDFG 41 to a functional unit or a register in the RTL structure.

The RTL change amount estimating unit 3 estimates and outputs an RTL structure change amount 50 necessary for a change equivalent to a change in the behavioral description 40 based on the above-described correspondence relationship and, as information in high-level synthesis of the behavioral description 40, register lifetime 43, bit-width information 44, functional unit/register sharing information 45, an operation result sharing information 46, behavioral description change information (information of a partially-changed behavioral description) 47, bit width change information 48, and a library 49. The details of the information will be described later. The RTL structure change amount 50 includes: component change information 51-1 to 51-n indicative of the number of addition pieces, area, delay, bit width, instance name, and the like of a functional unit, a register, and a multiplexer (MUX); MUX condition change information 52-1 to 52-n expressing a condition of selecting a multiplexer to be added or changed; and wire change information 53-1 to 53-n indicative of the number of wires to be connected or disconnected between components such as a functional unit and a register.

In the library 49, information of areas of various functional units and registers having different bit widths and delays in the components are stored. The library 49 is used by a high-level synthesis tool at the time of performing the high-level synthesis. In the embodiment, the information of areas and delays is also output to the component change information 51-1 to 51-n.

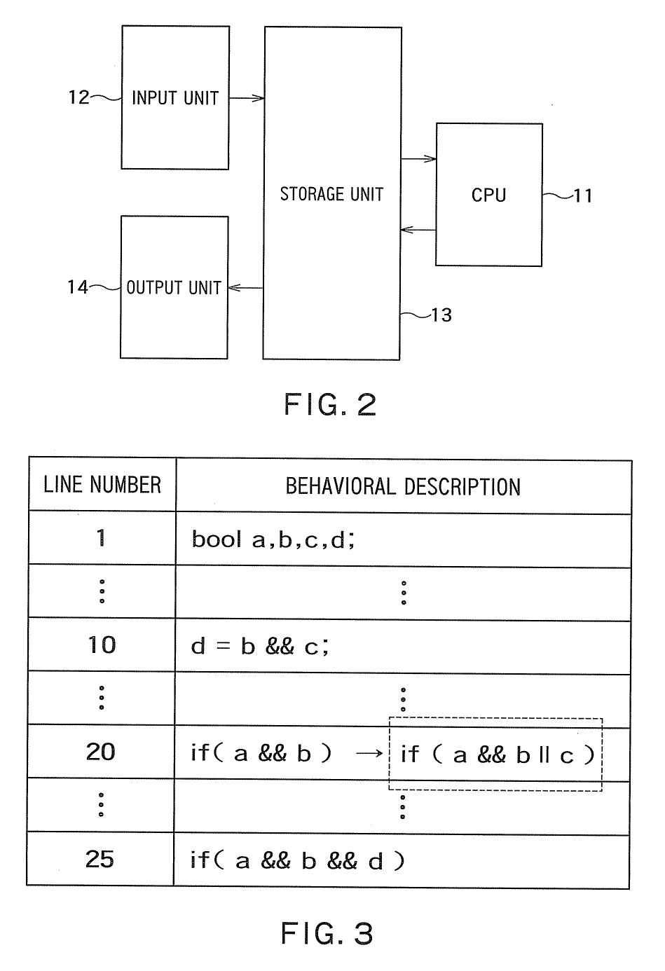

FIG. 2 is a hardware configuration diagram of the RTL structure change amount estimating apparatus as the first embodiment of the invention. The correspondence relationship creating unit 2 and the RTL change amount estimating unit 3 are included in a central processing unit (CPU) 11. An input unit 12 is a keyboard, a mouse, and the like. Using the input unit 12, a designer designates the behavioral description 40 which is input and a change point in the behavioral description 40 and the like. The storage unit 13 is a hard disk, a memory, and the like. In the storage unit 13, various information referred to by the correspondence relationship creating unit 2 and the RTL change amount estimating unit 3 is stored, such as the behavioral description 40, CDFG 41, functional unit binding information 42, register lifetime 43, bit width information 44, functional unit/register sharing information 45, computing result sharing information 46, behavioral description change information 47, bit width change information 48, and library 49. An output unit 14 is a display, a printer, and the like. The RTL structure change amount estimation result 50 output from the RTL change amount estimating unit 3 is provided to the designer in the form of display on the display or printout from the printer.

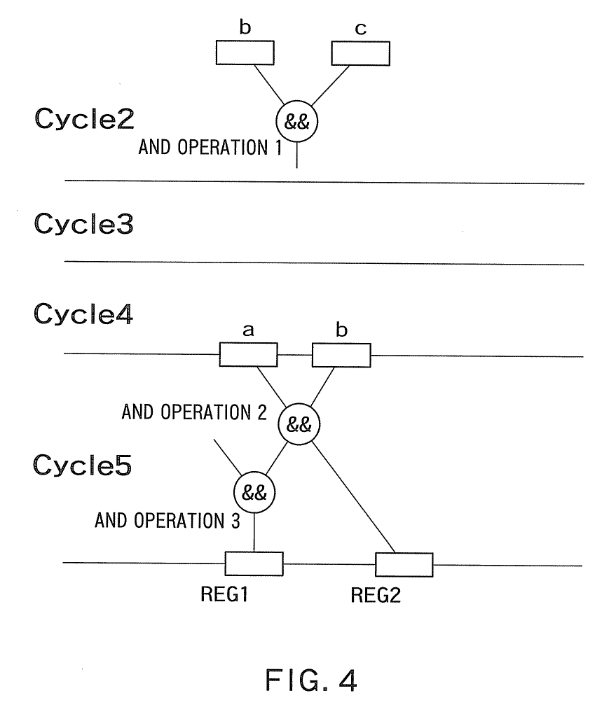

The process flow of the sub blocks of the RTL change amount estimating unit 3 in FIG. 1 will be described by using an example in which a behavioral description in the SystemC language and information of a change in the behavioral description shown in FIG. 3 is input. In the example, as shown in FIG. 3, a change of adding OR operation in the 20th line in the behavioral description is made. FIG. 4 shows a CDFG corresponding to the behavioral description before the change.

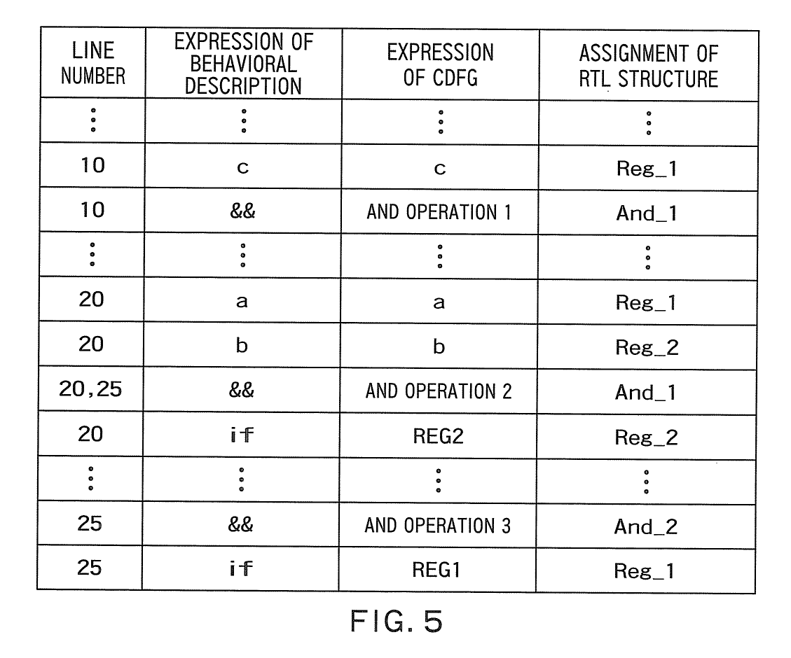

The RTL change amount estimating unit 3 receives correspondence relationships of a line number and expression of a behavioral description, expression of CDFG, and assignment of RTL structure as shown in FIG. 5 from the correspondence relationship creating unit 1, and estimates a change amount in the RTL structure in each of the sub blocks as described below.

First, the movable range searching unit 31 specifies an operation on the CDFG to which an operation to be changed corresponds based on the correspondence relationships shown in FIG. 5 and the information of the change in the behavioral description shown in FIG. 3. In the example, the change in the behavioral description is addition of an operation and the operation before the change does not exist in the CDFG. Consequently, the movable range searching unit 31 specifies, on the CDFG, an operation to which the AND operation corresponds, the AND operation being in the 20th line in the behavioral description shown in FIG. 3 as an operation just before the added operation. In the example, from the correspondence relationships shown in FIG. 5, it is specified that the AND operation corresponds to AND operation 2 in Cycle 5 in FIG. 4. An operation to be changed may be specified by using a changed behavioral description in place of the information of a change in the behavioral description.

After that, based on register lifetime (not shown) as one of high-level synthesis results, the movable range searching unit 31 obtains a range in which the changed operation (OR operation: the operation to be added) can move in a cycle (clock cycle) in the CDFG. The register lifetime is information indicative of variables stored in the registers cycle by cycle. The movable range of the changed operation is from “a first cycle in which an operand of the changed operation is determined” until “a cycle of executing an operation whose operand is a result of the changed operation”. The movable range searching unit 31 searches a cycle in which a variable as the operand exists with reference to the register lifetime. In the example, the operand of the OR operation to be added is the result of AND operation 2, so that the first cycle in which the OR operation can be set is Cycle 5 in which the AND operation 2 is executed. Although a cycle of executing an operation using the result of the OR operation as an operand is the latest cycle in which the OR operation can be set, the description will not be given for easier understanding. Next, the movable range searching unit 31 outputs the obtained movable range and, in the following sub blocks, estimates a change amount of the RTL structure in the case where the changed operation is set in each cycle in the movable range. Processes performed in the case of adding the OR operation in Cycle 5 will be described below.

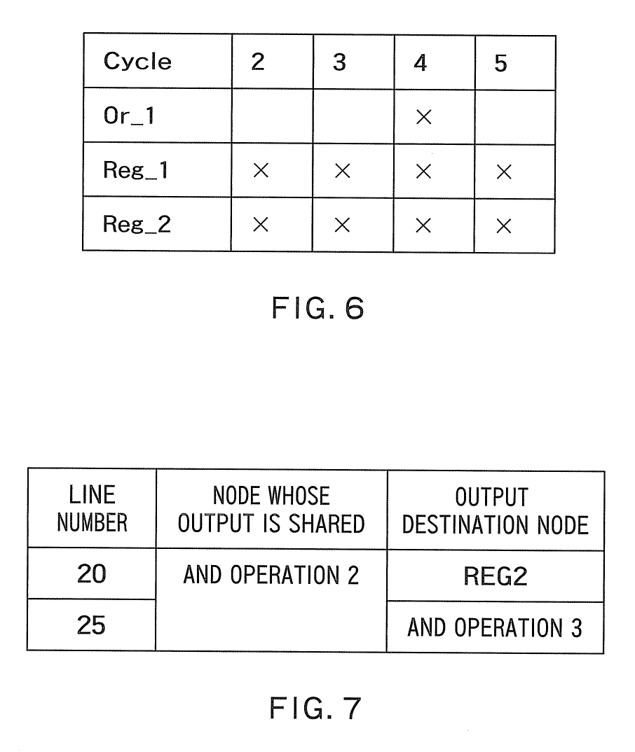

Next, the operand searching unit 32 checks whether an operand of a changed operation (operation to be added) exists in the cycle of executing the operation or not. In the example, the result of AND operation 2 in the operands of the OR operation to be added exists in Cycle 5 but a variable “c” in the operands of the OR operation to be added does not exist. Consequently, the operand searching unit 32 searches for a register that stores the variable “c” from cycles before Cycle 5 with reference to the register lifetime. In the example, the variable “c” is used as the operand of the AND operation 1 (the operation corresponding to the tenth line in the behavioral description shown in FIG. 3) in Cycle 2, so that the variable “c” is copied in the register and held until Cycle 5. At this time, the operand searching unit 32 checks whether a register for holding the variable “c” can be shared by another register or not based on functional unit/register sharing information indicating the functional unit/register name and whether the functional unit/register is used in each of cycles or not. In FIG. 6, in a cycle in which “X” is written, the corresponding register is already used and cannot be shared. In the example, since there is no available register in Cycle 2, a register is newly added. A wire between the register from which the variable “c” is copied and a register to be added has to be newly connected. Therefore, from the operand searching unit 32, as an estimation of a change amount in the RTL structure, information (first information) of “addition component: one register (1 bit)” and “wire change: one wire connected” is output.

Next, the bit width change amount estimating unit 33 estimates whether there is a component whose bit width is changed due to the change in the operation or not and a change amount in the component with reference to bit width information (not shown) indicative of names and bit widths of registers, functional units, and multiplexers. In the example, even when the OR operation is added, no change occurs in the bit width. Consequently, the process advances to the next block.

The functional unit sharability checking unit 34 checks whether the changed operation (the operation to be added) and another operation can share the same functional unit (existing component) in the RTL structure or not based on the functional unit/register sharing information shown in FIG. 6. In the example, referring to FIG. 6, a functional unit Or_1 in the RTL structure in Cycle 5 in which the OR operation is executed is available, so that the functional unit Or_1 can be shared, and an additional functional unit is unnecessary. In place of sharing, a multiplexer is needed at each of the input terminals of the functional unit Or_1. A condition of selecting an output of each of the multiplexers in Cycle4 and Cycle5 has to be input as a selection signal to each of the multiplexers As the change in the wire, an output of the functional unit Or_1 has to be connected to a register Reg_2 as an output destination of a functional unit And_1 to which AND operation 2 is assigned. The added multiplexer and the added register in which the operand (variable “c”) is stored have to be connected to each other. Therefore, from the functional unit sharability checking unit 34, as an estimation of the change amount in the RTL structure, information (second information) of “addition components: two 1-bit MUXs”, “MUX condition change: addition of MUXs (selection condition: Cycle 4 and Cycle 5)”, and “wire change: three wires connected”) is output.

Next, the operation result share state checking unit 35 checks whether an operation result (an operation result of the AND operation 2) whose output destination is changed is shared by another operation or not. When the same operation of the same operand is performed a plurality of times on a behavioral description, there is a case that the operation is not performed in a plurality of times on the RTL description, and high-level synthesis is performed so that one operation result is shared. In the case of changing only an operation in one part on a behavioral description, the influence of the change should not be exerted on all of output destinations of the result of the changed operation. Since the example relates to a change of adding an operation, a check is made to see whether a result of the AND operation 2 as an operation immediately before the operation to be added is shared or not. At this time, operation result sharing information as shown in FIG. 7 is referred to. The operation result sharing information is correspondence information among line numbers of behavioral descriptions of all of operations whose outputs are shared, names of operation nodes (nodes whose outputs are shared) on the CDFG, and names of nodes as output destinations of the operation. It is understood from the operation result sharing information shown in FIG. 7 that the AND operation 2 shares results in operations in the 20th and 25th lines in the behavioral description. Since the behavioral description is changed only in the 20th line, the OR operation is added to the output destination of the operation result in the 20th line (an output to the register REG2). Connection from the AND operation 2 to the register REG2 is disconnected. That is, in the RTL structure, connection from the functional unit And_1 to which the AND operation 2 is assigned to the register Reg_2 to which the register REG2 is assigned is disconnected. Therefore, from the operation result share state checking unit 35, information of “wire change: one wire disconnected” (third information) is output as an estimation of the change amount in the RTL structure.

Next, the operation share state checking unit 36 checks whether the operation to be deleted and another operation share a functional unit or not. Since the example relates to a change of adding an operation, it is unnecessary to consider this point.

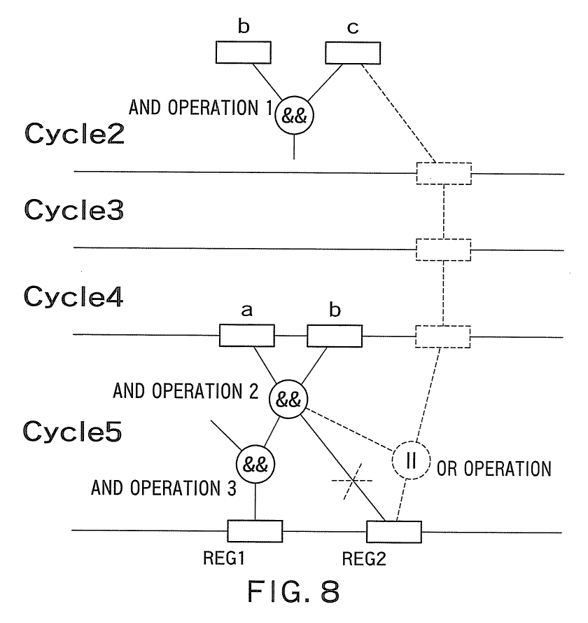

As a result, the CDFG after the change is as shown in FIG. 8. Particularly, parts expressed by broken lines in the diagram correspond to a changed operation and express the components and wires added. The part with “X” in the diagram expresses the deleted wire.

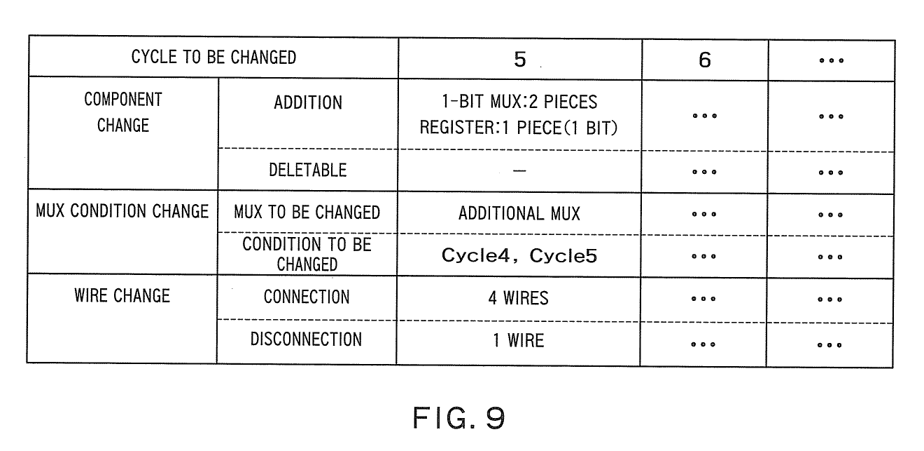

The RTL change amount estimating unit 3 outputs an estimation of change amounts in the RTL structure from the sub blocks, that is, information of “addition components: two 1-bit MUXs and one register (1 bit)”, “MUX condition change: addition of MUX (selection condition: Cycle 4 and Cycle 5)”, and “wire change: four wires connected and one wire disconnected”. Further, in a manner similar to the above, the RTL change amount estimating unit 3 obtains and outputs an estimation of a change amount in the RTL structure in the case where the OR operation is set in each of cycles obtained by the movable range searching unit 31. That is, from the RTL change amount estimating unit 3, as shown in FIG. 9, a result of estimation of a change amount in the RTL structure as a set of the component change information, the MUX condition change information, and the wire change information is output by the number of cycles in the movable range.

As the result of estimation of the change amount in the RTL structure, the instance name and the wire name are also output. By the names, the designer knows a part to be changed in the RTL structure and the RTL description.

As described above, in the embodiment, the change amount in the RTL structure accompanying a change in the behavioral description can be estimated before the RTL description is actually changed. Consequently, from the information, the designer can examine whether ECO is actually performed or not in advance. It can eliminate a wasteful backslide process of re-performing the operation from the high-level synthesis since it is found that, after a change in an RTL description is made manually, the change is not of a scale at which the ECO can be performed. By considering sharing of functional units, the change amount in the RTL structure is reduced as much as possible, and an estimation result, on the basis of which it is determined that the possibility of performing the ECO is high, can be output. As a result, the design period can be shortened. Further, by outputting an estimation result in each case where a cycle in which an operation to be changed is set is changed, the possibility of outputting a solution adapted to the circumstances of the designer becomes high.

### Second Embodiment

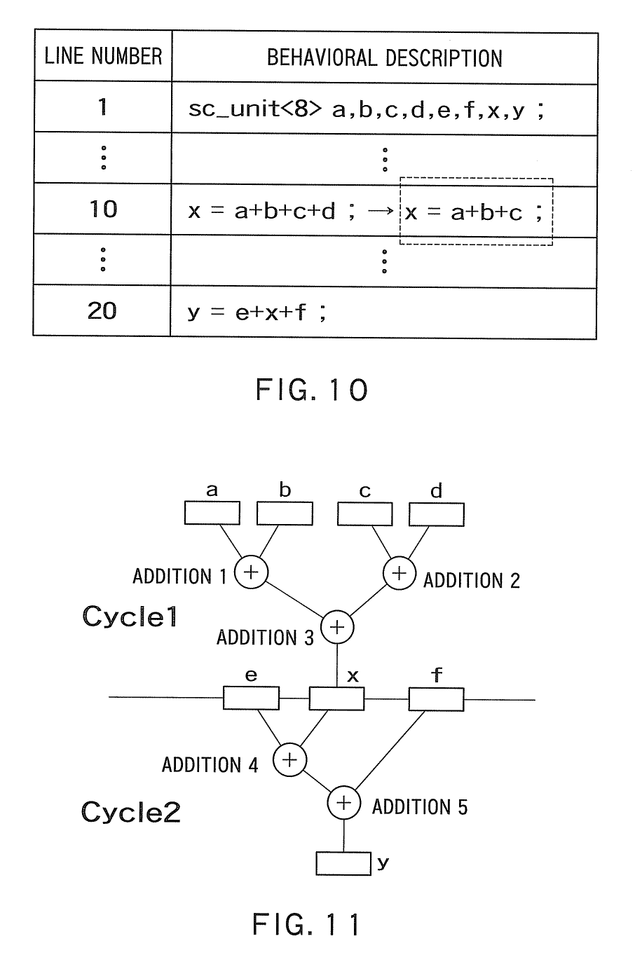

A second embodiment of the present invention will now be described with reference to FIGS. 10 to 15. In the embodiment, an example of performing a change in a behavioral description different from that of the first embodiment will be described. In the example, as shown in FIG. 10, a change of deleting addition in the tenth line in a behavioral description is made. FIG. 11 shows a CDFG corresponding to a behavioral description before the change in the example. Parts in which processes different from those in the first embodiment are performed will be mainly described, and detailed description on similar processes will not be repeated.

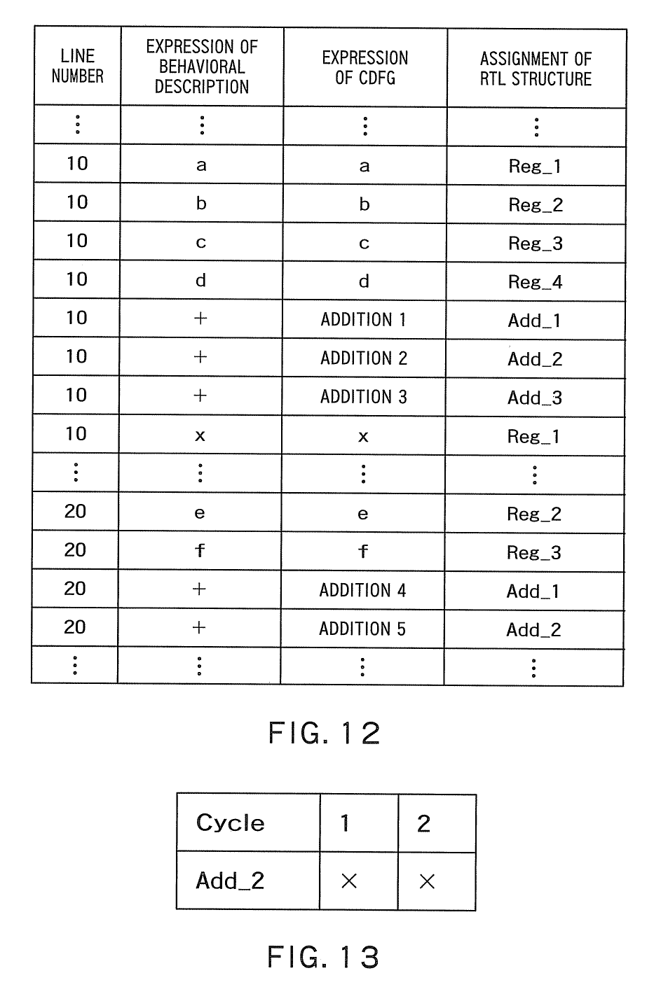

The correspondence relationship creating unit 2 outputs a correspondence relationship as shown in FIG. 12 by performing processes similar to those of the first embodiment.

Next, the RTL change amount estimating unit 3 estimates a change amount in the RTL structure accompanying a change in a behavioral description. However, the example relates to the change of deleting operation. It is therefore unnecessary to search the movable range of operation, and the movable range searching unit 31 does not perform any operation.

The operand searching unit 32 and the bit width change amount estimating unit 33 perform processes similar to those of the first embodiment.

Since the example relates to the change of deleting the operation, the functional unit sharability checking unit 34 does not perform any operation.

Next, the operation result share state checking unit 35 checks whether a result of the operation to be deleted (the addition 2 shown in FIG. 11) (an operation result whose output destination is to be changed) is shared in a plurality of places or not with reference to operation result sharing information (not shown). In the operation result sharing information, only information of an operation whose result is shared is shown. Since the operation result is not shared in the example, the wire between the addition 2 and the next operation (the addition 3 shown in FIG. 11) can be disconnected. Since one of the operands of the addition 3 is changed to the variable “c” from the result of the addition 2, the wire between the variable “c” and the addition 3 is connected. Therefore, from the operation result share state checking unit 35, information of “wire change: one wire connected and one wire disconnected” (third information) is output as an estimation of a change amount in the RTL structure.

The operation share state checking unit 36 checks whether an operation to be deleted (addition 2) and another operation share a functional unit in the RTL structure or not with reference to the functional unit/register sharing information shown in FIG. 13. It is understood from FIGS. 12 and 13 that an adder Add_2 to which the addition 2 is assigned is shared also in Cycle 2. Therefore, even if the addition 2 is deleted, the adder Add_2 cannot be deleted, so that nothing is output as an estimation of the change amount in the RTL structure.

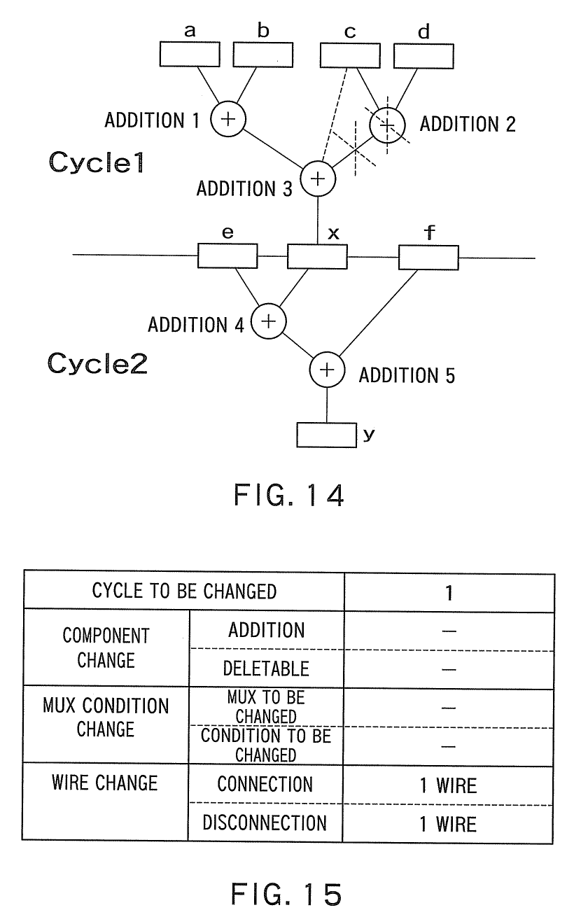

As a result, the changed CDFG becomes as shown in FIG. 14, and the RTL change amount estimating unit 3 outputs information of estimations of a change amount in the RTL structure from the sub blocks as shown in FIG. 15.

As described above, in the embodiment, changes of not only addition of an operation but also deletion of an operation can be handled. Therefore, by combining deletion and addition of an operation, a certain operation can be changed to another operation. It can widen the range of a design case to which the apparatus for estimating a change amount in an RTL structure as the embodiment can be applied. That is, the possibility of reducing the backslide process in various design cases becomes higher.

### Third Embodiment

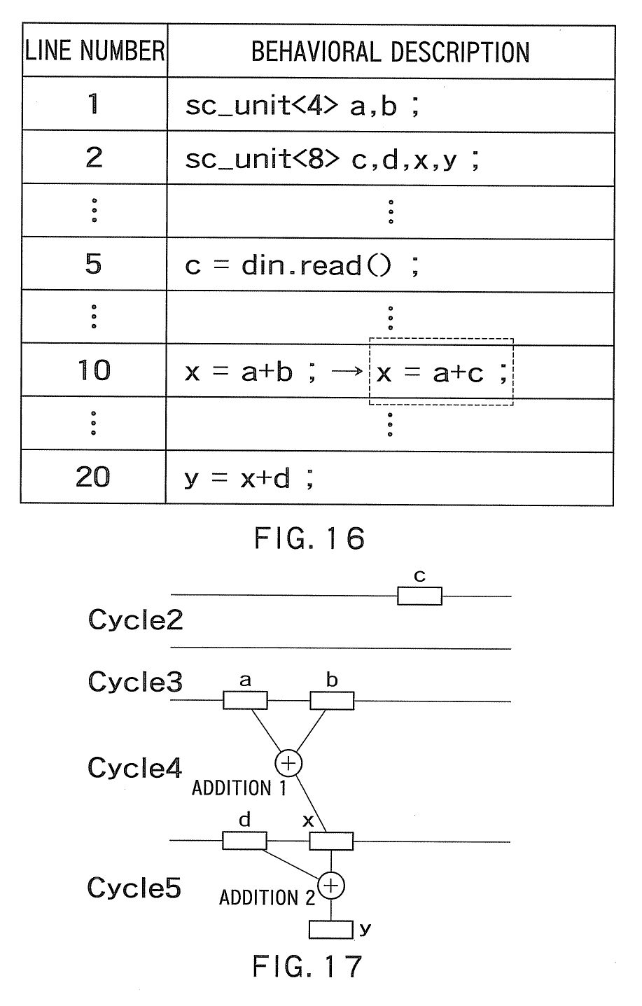

Next, a third embodiment of the present invention will be described with reference to FIGS. 16 to 23. In the embodiment, an example of performing a change in a behavioral description different from those in the first and second embodiments will be described. In the example, as shown in FIG. 16, a correction of changing an operand of addition is performed in the tenth line in the behavioral description. FIG. 17 shows a CDFG corresponding to a behavioral description before the change in the example. In the following, parts of performing processes different from those of the first and second embodiments will be mainly described, and detailed description of similar processes will not be repeated.

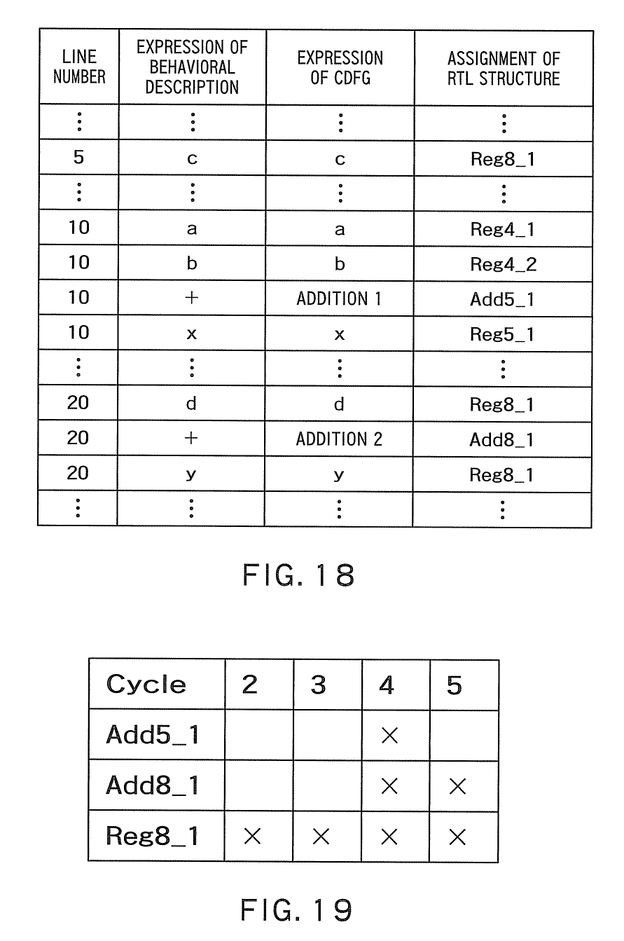

First, the correspondence relationship creating unit 2 performs processes in a manner similar to the first and second embodiments and outputs a correspondence relationship as shown in FIG. 18.

Subsequently, processes in the RTL change amount estimating unit 3 will be described. First, the movable range searching unit 31 searches a movable range on a CDFG of an operation to be changed. Since the example relates to a change in an operand, the movable range searching unit 31 searches a movable range of an operation using the operand to be changed (the addition 1 shown in FIG. 17: operation whose operand is to be changed). The searching method is similar to that of the first embodiment. In the following, the case of setting the addition 1 in Cycle 4 shown in FIG. 17 will be described.

Next, the operand searching unit 32 searches whether or not a changed operand exists in Cycle 4 in which the addition 1 as the operation using the operand to be changed is executed. That is, the operand searching unit 32 searches an operand “a” which is not changed and an operand “c” changed from an operand “b”. In the example, the cycle in which the addition 1 is set is the same as that before the change, so that the operand “a” naturally exists in Cycle 4, but the operand “c” to be changed does not exist. Due to this, the operand searching unit 32 goes back through the cycles and searches the operand “c” with reference to register lifetime (not shown). In the example, as understood from the CDFG shown in FIG. 17 and the correspondence relationships shown in FIG. 18, a register in which the variable “c” is stored exists in Cycle2, so that the variable “c” is copied to Cycle4. At this time, referring to the functional unit/register sharing information shown in FIG. 19, whether an existing register can be shared or not is checked. As understood from FIG. 19, an 8-bit register Reg8_1 is used in Cycle2 and subsequent cycles and cannot be shared, so that an existing register which can be shared does not exist. Consequently, one 8-bit register for copying the variable “c” of eight bits is added. In addition, a wire between the register in which the variable “c” is stored and the 8-bit register to which the variable “c” is to be copied has to be connected. Therefore, from the operand searching unit 32, as an estimation of a change amount in the RTL structure, information (first information) of “additional component: one register (8 bits)” and “wire change: one wire connected” is output.

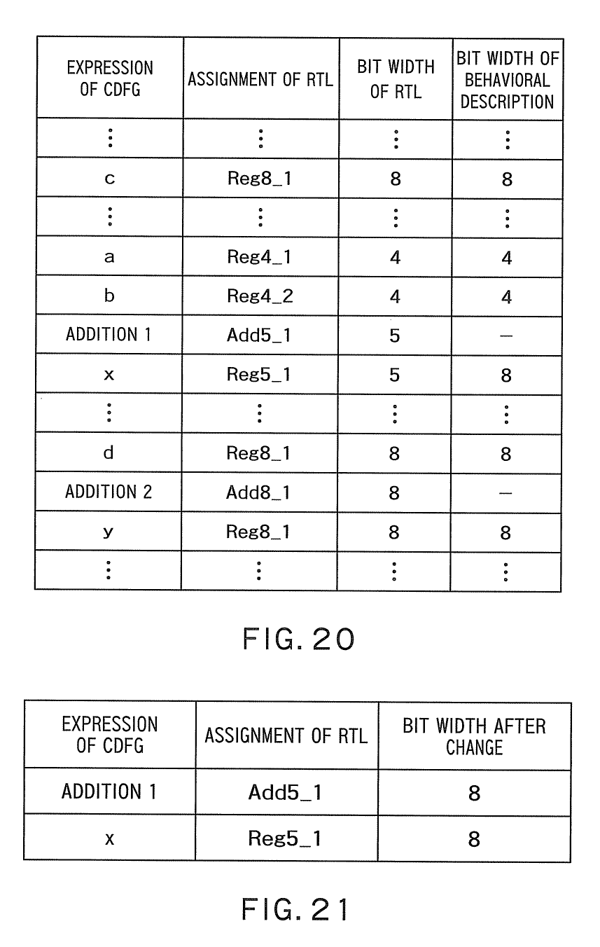

Next, the bit width change amount estimating unit 33 estimates whether the bit width of the component is changed due to the change in the operand or not and an amount of the change. At the time of estimation, bit width information indicative of a bit width assigned on the RTL description of each component and a bit width declared in the behavioral description as shown in FIG. 20 is referred to. In the example, one of operands of addition 1 is changed from a variable “b” of four bits to a variable “c” of eight bits. A variable “x” into which the result of the addition 1 is substituted is made of eight bits in declaration in the behavioral description shown in FIG. 16, but is assigned to a register (Reg5_1) of five bits when the correspondence relationships shown in FIG. 18 are referred to. The reason is that since operands of four bits are added, it is determined at the time of high-level synthesis that five bits are sufficient even a carry is included. That is, three bits are reduced. However, to store a result of the addition 1 in which the operand is changed to eight bits, the variable “x” has to be expanded to eight bits (extension of three bits). In addition, the adder to which the addition 1 is assigned has to be changed from a 5-bit adder to an 8-bit adder. Since declaration in the behavioral description is eight bits, the ninth bit of a carry may not be considered. As described above, the bit width determined as redundant in the high-level synthesis may be reduced more than the declaration in the behavioral description. Consequently, when a change in the bit width occurs due to a change in the behavioral description, the bit width reduced by the high-level synthesis has to be re-expanded. In the example, it is understood from the bit width information shown in FIG. 20 that the addition 2 in which the variable X becomes an operand (the 20th line in the behavioral description shown in FIG. 16) is assigned in eight bits. An 8-bit register which is the same as that in the declaration of the behavioral description is assigned also for the variable “y” into which the result of the addition 2 is substituted, so that the influence of the bit width change stops here. However, in the other cases, referring to the bit width information, the bit width has to be changed to a sufficient bit width at which the influence of the bit width change is absorbed. By the above operation, information of a component whose bit width has to be changed as shown in FIG. 21 is output from the bit width change amount estimating unit 33.

Next, the functional unit sharability checking unit 34 refers to the information of a component whose bit width has to be changed shown in FIG. 21 which is output from the bit width change amount estimating unit 33 and the functional unit/register sharing information shown in FIG. 19, and checks whether the component whose bit width is to be changed can be shared with an existing component. As understood from FIG. 19, the 8-bit adder Add8_1 is used in Cycle4, so that it cannot be shared. Therefore, a new 8-bit adder has to be added, and a wire between the 8-bit adder and the operand of the adder and a wire between the 8-bit adder and its output destination have to be connected. With respect to a register Reg5_1 in which the variable x is stored, by expanding the 5-bit register to an 8-bit register, the amount of change in the RTL structure is suppressed to be small. Therefore, from the functional unit sharability checking unit 34, as an estimation of a change amount in the RTL structure, information (second information) of “addition components: one 8-bit adder and one register (three bits)” and “wire change: three wires connected” is output.

Next, the operation result share state checking unit 35 checks whether a result of the addition 1 (a result of an operation whose output destination is to be changed) as an operation using an operand to be changed is shared or not. In the example, the result is not shared. Consequently, the output wire of the addition 1 may be disconnected. Therefore, from the operation result share state checking unit 35, as an estimation of a change amount in the RTL structure, information (third information) of “wire change: one wire disconnected” is output.

The operation share state checking unit 36 checks whether an adder Add5_1 to which the addition 1 (operation to be deleted) is assigned before a change in the behavioral description is shared with another operation or not. In this example, it is understood from the functional unit/register share information shown in FIG. 19 that since the adder Add5_1 is not shared, it may be deleted. Therefore, from the operation share state checking unit 36, information (fourth information) that “5-bit adder Add5_1 is deletable” is output as an estimation of the change amount in the RTL structure.

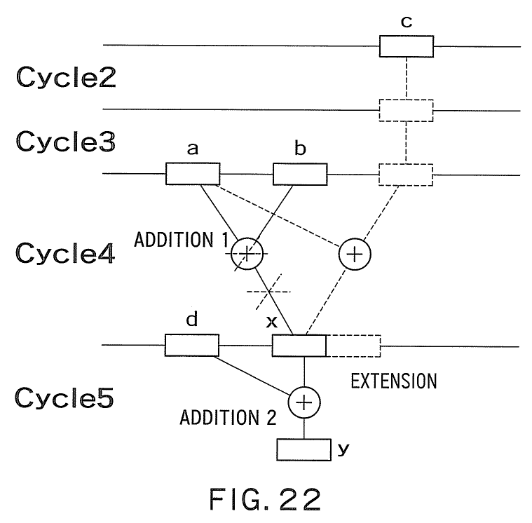

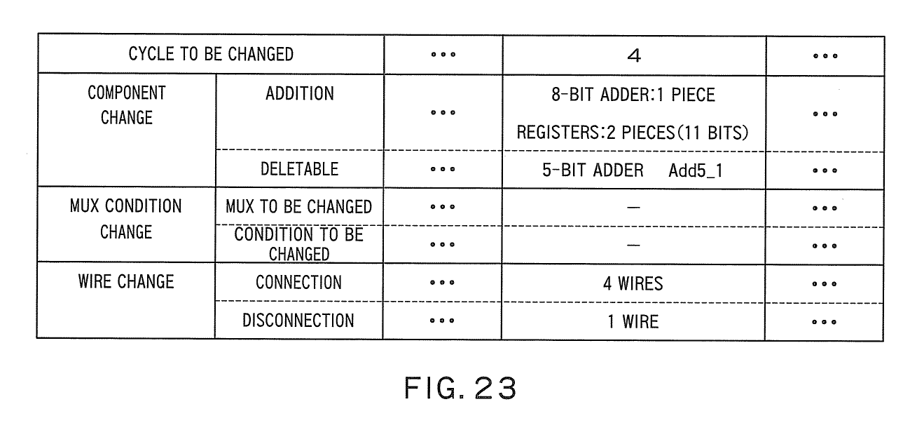

From the above, the changed CDFG becomes as shown in FIG. 22. From the RTL change amount estimating unit 3, information of estimations of change amounts in the RTL structure from the sub blocks as shown in FIG. 23 is output.

As described above, in the embodiment, the influence of a change in a bit width in an RTL description accompanying a change in a behavioral description can be also estimated, so that an estimation result of higher precision can be output. Consequently, a backslide process which occurs due to a determination error caused by an error in an estimation of a bit width can be reduced.

### Fourth Embodiment

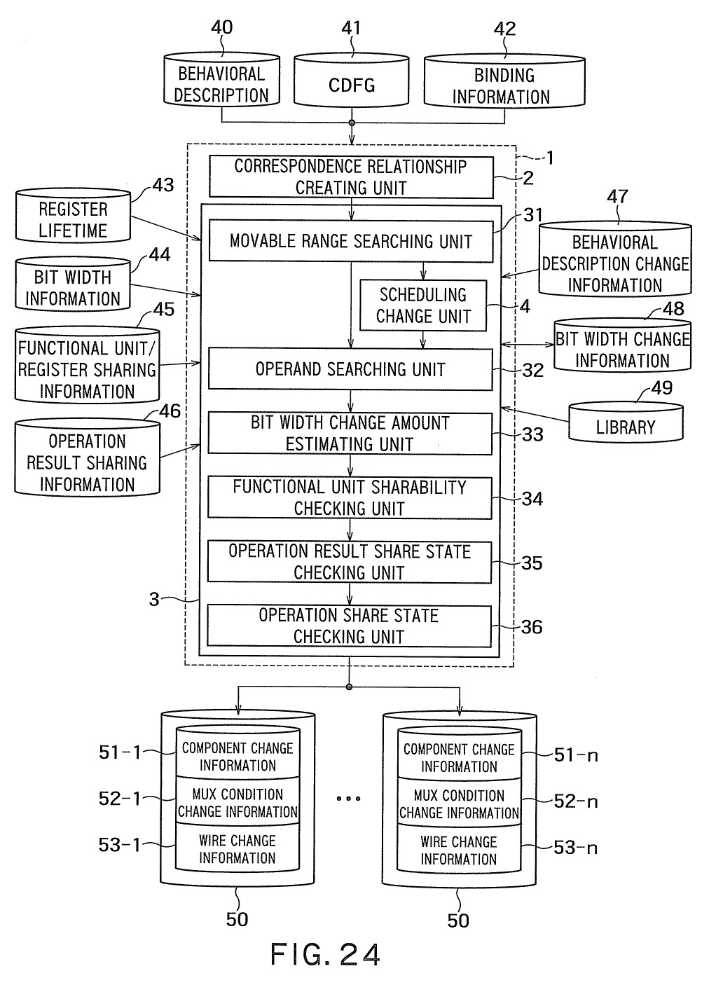

Next, a fourth embodiment of the present invention will be described with reference to FIGS. 24 to 29. The fourth embodiment is different from the first to third embodiments with respect to the point that a scheduling result in an RTL is changed by moving a cycle in which an operation for obtaining an operand after a change is executed onto a CDFG.

When high-level synthesis is used, due to automatic scheduling of a high-level synthesis tool, sharing of functional units, and the like, the operation order between the behavioral description and the RTL description may be changed. When a change part in the behavioral description corresponds to a part where the operation order is changed, there is a case that the change amount cannot be estimated in the first to third embodiments. In this case, a correct change amount cannot be estimate without changing the scheduling result in the RTL.

The configurations and processes different from those of the first to third embodiments will be mainly described, and the detailed description of similar configurations and processes will not be repeated.

FIG. 24 is a block diagram showing a general configuration of an apparatus for estimating a change amount in an RTL structure as a fourth embodiment of the present invention. An apparatus 10 for estimating a change amount in an RTL structure has the correspondence relationship creating unit 2 and an RTL change amount estimating unit 30. The RTL change amount estimating unit 30 has, in addition to the configuration of the RTL change amount estimating unit 3 in FIG. 1, a scheduling change unit 4 between the movable range searching unit 31 and the operand searching unit 32.

In a manner similar to the first to third embodiments, using an existing technique, the correspondence relationship creating unit 2 creates a correspondence relationship between a line number of the behavioral description 40, expression of the behavioral description 40, expression of the CDFG 41, and allocation of an RTL structure from the behavioral description 40 which is input, the CDFG 41 which is input, and the functional unit binding information 42 at the time of high-level synthesis which is input.

In a manner similar to the first to third embodiments, the RTL change amount estimating unit 30 performs the following process by the movable range searching unit 31, the operand searching unit 32, the bit width change amount estimating unit 33, the functional unit sharability checking unit 34, the operation result share state checking unit 35, and the operation share state checking unit 36. Specifically, the RTL structure change amount 50 necessary for a change equivalent to a change in the behavioral description 40 is estimated and output based on the above-described correspondence relationship and, as information in high-level synthesis of the behavioral description 40, the register lifetime 43, the bit-width information 44, the functional unit/register sharing information 45, the operation result sharing information 46, the behavioral description change information 47, the bit width change information 48, and the library 49. The RTL structure change amount 50 includes: the component change information 51-1 to 51-n indicative of the number of addition pieces, area, delay, bit width, instance name, and the like of a functional unit, a register, and a multiplexer (MUX); the MUX condition change information 52-1 to 52-n expressing a condition of selecting a multiplexer to be added or changed; and wire change information 53-1 to 53-n indicative of the number of wires to be connected or disconnected between components such as a functional unit and a register.

The scheduling change unit 4 is called by the movable range searching unit 31 when the operation order between a behavioral description (SystemC description) and the RTL description is changed in a change part in the behavioral description which cannot be handled by components from the movable range searching unit 31 to the operation share state checking unit 36 in the RTL change amount estimating unit 30. The scheduling change unit 4 attempts to change the operation scheduling in the RTL. There is the possibility that a change in the operation order becomes a problem in the case of changing an operand itself and in the case of adding an operand due to addition of an operation. The case of adding an operand due to addition of an operation refers to, for example, as described in the first embodiment, the case of adding an operand “c” (operand to be added) by adding an OR operation (operation to be added).

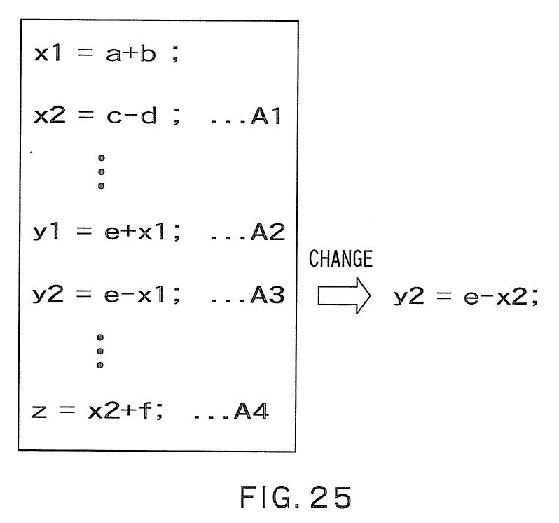

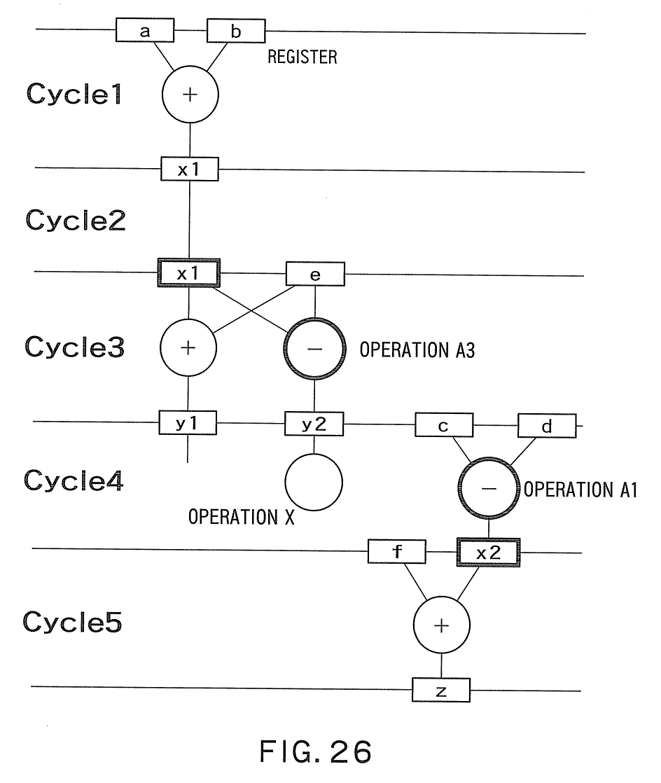

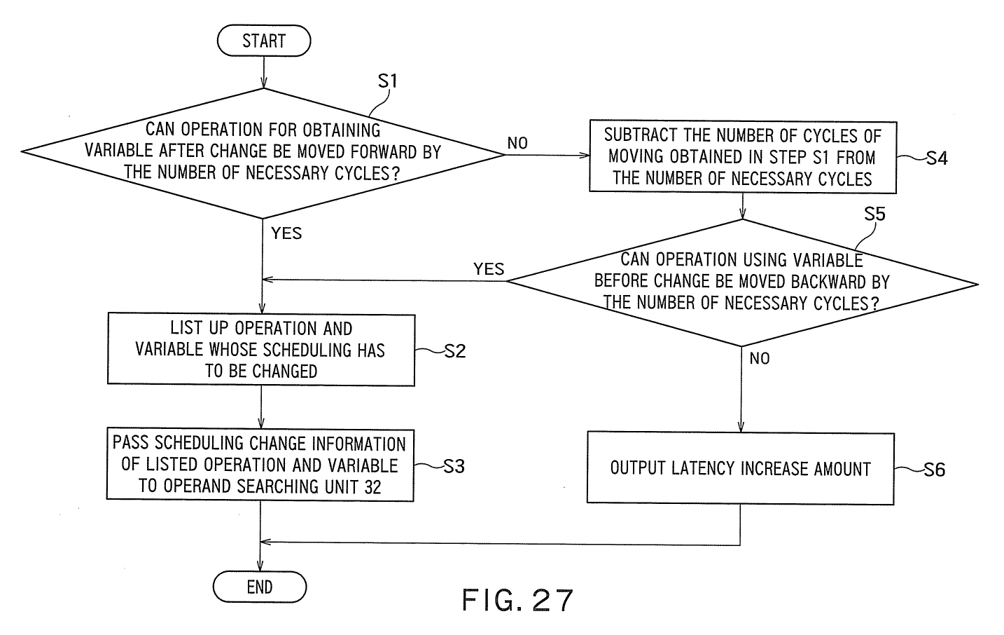

FIGS. 25 and 26 show an example of a change in the operation order which cannot be handled in the first to third embodiments in the case of changing an operand itself. FIG. 26 shows a scheduling result (CDFG) in the RTL obtained by performing high-level synthesis on the behavioral description (SystemC description) of FIG. 25. In the behavioral description (SystemC description), an operation A1 for obtaining a variable x2 is described before operations A2 and A3 for obtaining variables y1 and y2, respectively. However, the value of the variable x2 is referred to for the first time by an operation A4 for obtaining a variable z which is described after the operations A2 and A3. Due to this, at the time of high-level synthesis, it is determined that execution of the operation A1 at an early stage is unnecessary, and there is the possibility that scheduling is performed so that the operation A1 is executed after the operations A2 and A3 in the RTL as shown in FIG. 26. An example of changing the operand of the operation A3 from the variable x1 to the variable x2 as shown in FIG. 25 is considered. At a timing (Cycle3) of executing the operation A3 in the RTL, the operation A1 for generating the variable x2 is not executed yet, so that the scheduling of operations has to be changed.

In the example of FIG. 26, an operation X using the variable y2 as the operand is executed in Cycle4. Consequently, the movable range searching unit 31 cannot move the operation A3 to subsequent cycles (after Cycle4). Therefore, in the methods of the first to third embodiments, the change in the operation order cannot be solved, and a change amount of the RTL structure cannot be estimated.

Next, the operation of the RTL structure change amount estimating apparatus 10 in the case where the operation order changes as described above will be described.

First, in a manner similar to the first and third embodiments, the movable range searching unit 31 obtains, with reference to the register lifetime, “the first cycle in which an operand (the variables x2 and “e” in the example of FIG. 26) after a change of an operation whose operand is to be changed (operation A3 in the example of FIG. 26) is determined” and “a cycle of executing an operation (the operation X in the example of FIG. 26) whose operand is a result of the operation whose operand is to be changed (variable y2 in the example of FIG. 26)”. In the case where the former cycle (Cycle5) is behind the latter cycle (Cycle4) like in the example of FIG. 26, it is determined that a change in the operation order which cannot be handled in the first and third embodiments occurs in a change part in the behavioral description. In this case, the movable range searching unit 31 calls the scheduling change unit 4.

In the case where the latter cycle is behind the former cycle, the movable range searching unit 31 does not call the scheduling change unit 4, and processes similar to those in the first and third embodiments are performed.

The scheduling change unit 4 changes scheduling in accordance with the flowchart of FIG. 27.

In step S1, a check is made to see whether an operation (operation A1 in the example of FIG. 26) for obtaining a changed operand (variable x2 in the example of FIG. 26) can be moved the number of necessary cycles to preceding cycles or not. The number of necessary cycles is the number of cycles necessary to create the variable x2 before execution of the operation A3 using, as an operand, the variable x1 desired to be replaced with the variable x2, and is two cycles in this case.

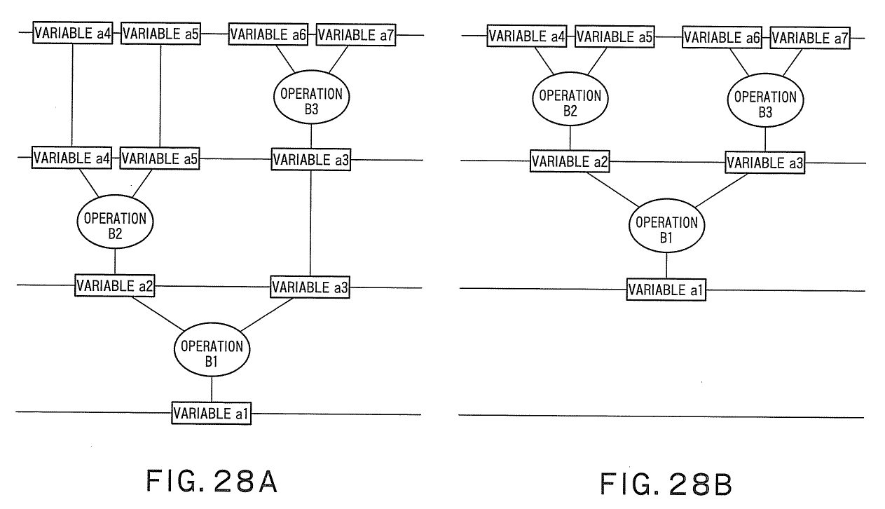

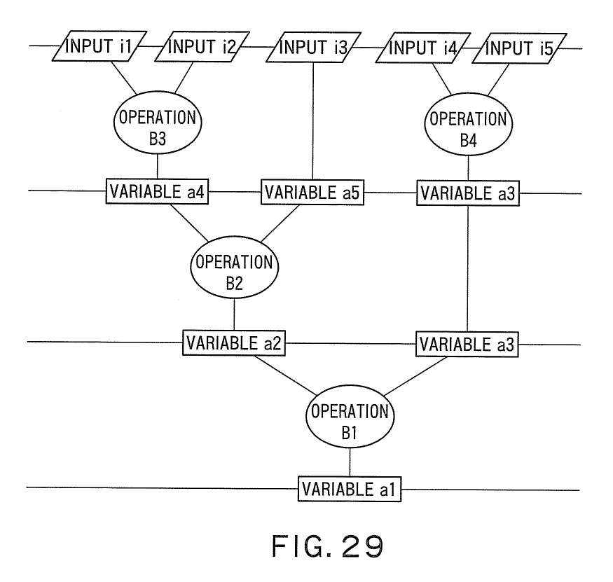

To move an operation to a preceding cycle, a space for setting the operation, in a cycle preceding the operation, has to be found. As a simple method, a cycle for only transferring data between registers or retaining data without executing an operation is found before the operation desired to be moved. For example, a CDFG in FIG. 28A will be considered. In the case where the operation B1 is desired to be moved to the immediately preceding cycle, one cycle (space) for performing only data transfer or retention is found via all of inputs of the operation B1. In the path of the variable a2, there is an operation B2 before a space is found, and a path for inputs is branched. In the case where a branch is encountered before a space enough for the number of necessary cycles is found, the number of spaces found until then is taken over, and spaces of the insufficient amount are recursively found at branches. In the example, one cycle for performing only data transfer or retention exits in each of the path of the variable a4 and the path of the variable a5. The number of necessary cycles becomes sufficient in both of the paths, so that the search is finished. In the path of the variable a3, there is a space before a branch is encountered. Since the number of necessary cycles becomes sufficient, the search is finished. In such a manner, spaces of the number of necessary cycles are found at all of branches from the operation B1. Therefore, as shown in FIG. 28B, the operation B2 is moved to the immediately preceding cycle and, then, the operation B1 can be moved to the immediately preceding cycle. That is, a change in the operation order can be prevented. In the case where the operation can be moved by the number of necessary cycles as described above, the process advances to step S2. However, in the case where a space of the number of necessary cycles cannot be found in a path to an input from the outside in any one of paths at the time of the search like a path from a variable a1 to an input i1 and a path from the variable a1 to an input i2 in FIG. 29, the number of the smallest spaces in all of the paths is set as the maximum cycle number in which the operation can be moved, the search is finished, and the process advances to step S4 as will be described later.

In step S2, scheduling change information of an operation and variable whose scheduling has to be changed as a result of moving the operation for obtaining an operand after a change to a preceding cycle are listed up. In the scheduling change information, “operation/variable in a behavioral description (SystemC description)”, “functional unit/register in the RTL structure”, “an execution cycle before a change in the scheduling”, and “an execution cycle after a change in the scheduling” are described so as to be associated. In the example of FIGS. 28A and 28B, scheduling of the operations B1 and B2 and the variables a1 and a2 are changed to the immediately preceding cycle, so that the scheduling change information is listed up.

In step S3, the scheduling change information of the operations and variables listed up in step S2 are passed to the operand searching unit 32.

Based on the scheduling change information, the operand searching unit 32, the bit width change amount estimating unit 33, the functional unit sharability checking unit 34, the operation result share state checking unit 35, and the operation share state checking unit 36 estimate and output a change amount in the RTL structure in a manner similar to the first to third embodiments. That is, in the sub blocks, a check is made to see whether the operations and variables listed up can share an existing functional unit and an existing register in a cycle after the scheduling is changed with reference to the correspondence relationship between the expression of the CDFG and the assignment of the RTL structure and the functional unit/register sharing information. In the case where the exiting functional unit and the existing register can be shared, a change in the RTL structure is only a control signal of the MUX. In the case where they cannot be shared, a functional unit and a register have to be newly added.

Concretely, the operand searching unit 32, the bit width change amount estimating unit 33, the functional unit sharability checking unit 34, the operation result share state checking unit 35, and the operation share state checking unit 36 perform processes in order on the operations in the scheduling change information from the operation in the early cycle. In the example of FIGS. 28A and 28B, first, a change amount in the RTL structure in the operation B2 in the early cycle is estimated. Subsequently, a change amount in the RTL structure in the operation B1 is estimated.

Finally, a change in the operation order is stopped and, with respect to an operation whose operand is to be changed, a change amount in the RTL structure is estimated in a manner similar to the third embodiment. The RTL change amount estimating unit 30 outputs a result of estimation of the change amount in the RTL structure in a manner similar to the first to third embodiments.

On the other hand, in the case where the operation cannot be moved to a preceding cycle by the number of necessary cycles in step S1, the process advances to step S4. In step S4, the maximum number of cycles which can be moved to preceding cycles obtained in step S1 is subtracted from the number of necessary cycles, and the process advances to step S5. In the example of FIG. 26, if the operation A1 can be moved to the immediately preceding cycle, the number of necessary cycles becomes one(=2−1).

In step S5, a check is made to see whether the operation (the operation A3 in the example of FIG. 26) using a variable before the change (the variable x1 in the example of FIG. 26) (that is, the operation whose operand is to be changed) can be moved backward by the number of necessary cycles updated in step S4 or not. The searching method is similar to that in the case of moving the operation to a preceding cycle in step S1, and a space of the number of necessary cycles is found via an output of the operation desired to be moved. In the case where there is a space of the number of necessary cycles in all of paths reaching an output to the outside, the process advances to step S2 and, after that, advances to step S3. In a manner similar to the case of moving the operation to a preceding cycle, the change amount in the RTL structure necessary as a result of changing the schedule is estimated by the operand searching unit 32 or the like and output.

In the case where a space of the number of necessary cycles cannot be found in any one of the paths in step S5, the maximum number of cycles of moving the operation is obtained in a manner similar to the step S1, and the process advances to step S6. In the case of moving the operation to a backward cycle, different from the case of moving the operation to a preceding cycle, the operation can be moved by any cycles by extending latency. However, when the latency is extended, there is the possibility that a change amount in the RTL structure becomes too large, and the specifications may be influenced. In this case, therefore, not an estimation of a change amount in the RTL structure but a latency increase amount indicating that the latency has to be increased by the number of cycles is output. The latency increase amount is a value obtained by subtracting the maximum number of cycles obtained in step S5 from the number of necessary cycles.

That is, in the case where a change of the operation order cannot be prevented, the scheduling change unit 4 outputs the latency increase amount, and the RTL change amount estimating unit 30 outputs the latency increase amount in place of the change amount in the RTL structure.

As described above, in the embodiment, the cycle in which the operation for obtaining an operand after a change is executed is moved on the CDFG at the time of ECO in the RTL description subjected to high-level synthesis. Consequently, a change in the operation order between the behavioral level and the RTL which cannot be prevented in the first to third embodiments is prevented, and a change amount in the RTL structure can be estimated. Therefore, the number of cases which can be handled increases. As a result, in many cases, the designer can promptly make a decision to perform the ECO on the RTL description or perform the high-level synthesis again. The backslide process of re-performing operations from the high-level synthesis to the lower process in spite of a scale which can be corrected by the ECO can be reduced.

In the case of also adding an operand by addition of an operation, in the above-described process, it is sufficient to use the “operation to be added” in place of the “operation whose operand is to be changed”, and use the “operand to be added” in place of the “operand after the change”.

The above-described method of estimating a change amount in the RTL structure can be executed by controlling the RTL structure change amount estimating apparatus shown in FIG. 2 by a program. The program may be stored in the storage unit 13 as a component of the RTL structure change amount estimating apparatus shown in FIG. 2. By storing the program in a computer-readable recording medium and making the storage unit 13 read the program using the recording medium as shown in FIG. 2, a method of estimating a series of RTL structure change amounts can be executed.

Although the embodiments of the present invention have been described in detail above, the concrete configurations are not limited to the foregoing embodiments but can be variously modified without departing from the gist of the present invention.

1. An apparatus for estimating a change amount in a register transfer level structure, comprising:
a correspondence relationship creating unit which describes a correspondence relationship among a behavioral description, a control data flow graph, and a register transfer level structure of a register transfer level description created by performing high-level synthesis on the behavioral description, based on the behavioral description which is input, the control data flow graph which is input and created by performing high-level synthesis on the behavioral description, and binding information which is input and created by performing high-level synthesis on the behavioral description; and
a register transfer level change amount estimating unit which estimates and outputs a change amount in the register transfer level structure, the change amount in the register transfer level structure being necessary to change the register transfer level description to a description equivalent to a partially changed behavioral description, based on information of the partially changed behavioral description obtained by partially changing the behavioral description and the created correspondence relationship.

2. The apparatus for estimating a change amount in a register transfer level structure according to claim 1, wherein the register transfer level change amount estimating unit comprises:
an operand searching unit which searches an operand in an operation to be added due to a change in the behavioral description or in an operation whose operand is to be changed due to a change in the behavioral description, and outputs first information as an estimation of the change amount in the register transfer level structure based on the search result;
a bit width change amount estimating unit which estimates a change amount of a bit width of a component due to the change in the behavioral description;
a functional unit sharability checking unit which checks whether the operation to be added or the component whose bit width is to be changed can share an existing component or not, and outputs second information as the estimation of the change amount in the register transfer level structure based on the check result;
an operation result share state checking unit which checks whether an operation result whose output destination is to be changed due to the change in the behavioral description is shared or not and, based on a result of the check, outputs third information as the estimation of the change amount in the register transfer level structure; and
an operation share state checking unit which checks whether a component is shared by both an operation to be deleted due to the change in the behavioral description and another operation or not and, based on a result of the check, outputs fourth information as the estimation of the change amount in the register transfer level structure.

3. The apparatus for estimating a change amount in a register transfer level structure according to claim 2, wherein in the case where a variable as the operand does not exist in a cycle for executing the operation,
the operand searching unit is configured to
search for a register that stores the variable from a preceding cycle based on register lifetime in which variables stored in each of the registers are shown on a cycle unit basis,
check whether or not the register for holding the variable can be shared until the cycle for executing the operation based on functional unit/register sharing information indicating whether the component is used in each of the cycles or not, and
output, as the first information, additional register information and wire change information based on a result of the check.

4. The apparatus for estimating a change amount in a register transfer level structure according to claim 2,
wherein the bit width change amount estimating unit is configured to estimate a change amount of the bit width of the component based on bit width information indicative of the component and bit width of the component,
the functional unit sharability checking unit is configured to check whether the existing component can be shared or not based on functional unit/register sharing information indicative of whether the existing component is used in each of the cycles or not and output, as the second information, additional component information and wire change information,
the operation result share state checking unit is configured to check whether or not the operation result whose output destination is to be changed is shared or not based on operation result sharing information and output, as the third information, disconnection information of a wire corresponding to the operation result which is not shared, and
the operation share state checking unit is configured to check whether the operation to be deleted shares the component with the another operation or not based on the functional unit/register sharing information and, in the case where the component is not shared, output information of the component which can be deleted as the fourth information.

5. The apparatus for estimating a change amount in a register transfer level structure according to claim 1, wherein the register transfer level change amount estimating unit comprises a movable range searching unit which searches a range of a cycle in the control data flow graph, in which an operation to be added due to the change in the behavioral description or an operation whose operand is to be changed due to the change in the behavioral description can be disposed, and
the register transfer level change amount estimating unit is configured to, in each case where the operation to be added or the operation whose operand is to be changed is disposed in each cycle in the range of the cycles, output an estimation of the change amount in the register transfer level structure.

6. The apparatus for estimating a change amount in a register transfer level structure according to claim 5, wherein the range of the cycles is set from a first cycle in which an operand of the operation to be added or a changed operand in the operation whose operand is to be changed is determined until an operation execution cycle in which a result of the operation to be added or a result of the operation whose operand is to be changed becomes an operand.

7. The apparatus for estimating a change amount in a register transfer level structure according to claim 1, wherein the register transfer level change amount estimating unit comprises a scheduling change unit, when a change part in the behavioral description corresponds to a part in which an operation order of the behavioral description and the register transfer level description is changed, outputs scheduling change information for canceling the change in the operation order, and
the register transfer level change amount estimating unit is configured to estimate and output the change amount in the register transfer level structure based on the scheduling change information.

8. The apparatus for estimating a change amount in a register transfer level structure according to claim 7, wherein the register transfer level change amount estimating unit comprises a movable range searching unit which searches a range of a cycle in the control data flow graph, in which an operation to be added due to the change in the behavioral description or an operation whose operand is to be changed due to the change in the behavioral description can be disposed,
the range of cycles is set from a first cycle in which an operand of the operation to be added or a changed operand in the operation whose operand is to be changed is determined until an operation execution cycle in which a result of the operation to be added or a result of the operation whose operand is to be changed becomes an operand, and
in the case where the former cycle is behind the latter cycle, the scheduling change unit is configured to cancel the change in the operation order by moving a cycle where an operation for obtaining an operand to be added of the operation to be added or an operation for obtaining a changed operand of the operation whose operand is to be changed is executed, on the control data flow graph.

9. The apparatus for estimating a change amount in a register transfer level structure according to claim 8,
wherein the scheduling change unit is configured to output a latency increase amount in the case where the change in the operation order cannot be cancelled, and
the register transfer level change amount estimating unit is configured to output the latency increase amount in place of the change amount in the register transfer level structure.

10. The apparatus for estimating a change amount in a register transfer level structure according to claim 1, further comprising a high-level synthesis apparatus for creating the control data flow graph, the binding information, and the register transfer level description from the behavioral description.

11. A method for estimating a change amount in a register transfer level structure, comprising:
describing a correspondence relationship among a behavioral description, a control data flow graph, and a register transfer level structure of a register transfer level description created by performing high-level synthesis on the behavioral description, based on the behavioral description which is input, the control data flow graph which is input and created by performing high-level synthesis on the behavioral description, and binding information which is input and created by performing high-level synthesis on the behavioral description by a correspondence relationship creating unit; and
estimating and outputting a change amount in the register transfer level structure, the change amount in the register transfer level structure being necessary to change the register transfer level description to a description equivalent to a partially changed behavioral description, based on information of the partially changed behavioral description obtained by partially changing the behavioral description and the created correspondence relationship by a register transfer level change amount estimating unit.

12. The method for estimating a change amount in a register transfer level structure according to claim 11, wherein the estimating and the outputting the change amount in the register transfer level structure comprises:
searching an operand in an operation to be added due to a change in the behavioral description or in an operation whose operand is to be changed due to a change in the behavioral description, and outputting first information as an estimation of the change amount in the register transfer level structure based on the search result by an operand searching unit in the register transfer level change amount estimating unit;
estimating a change amount of a bit width of a component due to the change in the behavioral description by a bit width change amount estimating unit in the register transfer level change amount estimating unit;
checking whether the operation to be added or the component whose bit width is to be changed can share an existing component or not, and outputting second information as the estimation of the change amount in the register transfer level structure based on the check result by a functional unit sharability checking unit in the register transfer level change amount estimating unit;
checking whether an operation result whose output destination is to be changed due to the change in the behavioral description is shared or not and, based on a result of the check, outputting third information as the estimation of the change amount in the register transfer level structure by an operation result share state checking unit in the register transfer level change amount estimating unit; and
checking whether a component is shared by both an operation to be deleted due to the change in the behavioral description and another operation or not and, based on a result of the check, outputting fourth information as the estimation of the change amount in the register transfer level structure by an operation share state checking unit in the register transfer level change amount estimating unit.

13. The method for estimating a change amount in a register transfer level structure according to claim 11, wherein the estimating and the outputting the change amount in the register transfer level structure comprises:
searching a range of a cycle in the control data flow graph, in which an operation to be added due to the change in the behavioral description or an operation whose operand is to be changed due to the change in the behavioral description can be disposed by a movable range searching unit in the register transfer level change amount estimating unit; and
in each case where the operation to be added or the operation whose operand is to be changed is disposed in each cycle in the range of the cycles, outputting an estimation of the change amount in the register transfer level structure from the register transfer level change amount estimating unit.

14. The method for estimating a change amount in a register transfer level structure according to claim 11, wherein the estimating and the outputting the change amount in the register transfer level structure comprises:
when an operation order of the behavioral description and the register transfer level description is changed in a change part in the behavioral description, outputting scheduling change information for canceling the change in the operation order by a scheduling change unit in the register transfer level change amount estimating unit; and
estimating and outputting the change amount in the register transfer level structure based on the scheduling change information by the register transfer level change amount estimating unit.

15. The method for estimating a change amount in a register transfer level structure according to claim 11, further comprising creating the control data flow graph, the binding information, and the register transfer level description from the behavioral description by a high-level synthesis apparatus.

16. A computer-readable recording medium storing a computer program for making a computer execute an estimation of a change amount in a register transfer level structure,
wherein the computer program makes the computer
describe a correspondence relationship among a behavioral description, a control data flow graph, and a register transfer level structure of a register transfer level description created by performing high-level synthesis on the behavioral description, based on the behavioral description which is input, the control data flow graph which is input and created by performing high-level synthesis on the behavioral description, and binding information which is input and created by performing high-level synthesis on the behavioral description and
estimate and output a change amount in the register transfer level structure, the change amount in the register transfer level structure being necessary to change the register transfer level description to a description equivalent to a partially changed behavioral description, based on information of the partially changed behavioral description obtained by partially changing the behavioral description and the created correspondence relationship.

17. The computer-readable recording medium according to claim 16, wherein the register transfer level structure change amount estimating and outputting operation comprises:
searching an operand in an operation to be added due to a change in the behavioral description or in an operation whose operand is to be changed due to a change in the behavioral description, and outputting first information as an estimation of the change amount in the register transfer level structure based on the search result;
estimating a change amount of a bit width of a component due to the change in the behavioral description;
checking whether the operation to be added or the component whose bit width is to be changed can share an existing component or not, and outputting second information as the estimation of the change amount in the register transfer level structure based on the check result;
checking whether an operation result whose output destination is to be changed due to the change in the behavioral description is shared or not and, based on a result of the check, outputting third information as the estimation of the change amount in the register transfer level structure; and
checking whether a component is shared by both an operation to be deleted due to the change in the behavioral description and another operation or not and, based on a result of the check, outputting fourth information as the estimation of the change amount in the register transfer level structure.

18. The computer-readable recording medium according to claim 16, wherein the register transfer level structure change amount estimating and outputting operation comprises:
searching a range of a cycle in the control data flow graph, in which an operation to be added due to the change in the behavioral description or an operation whose operand is to be changed due to the change in the behavioral description can be disposed; and
in each case where the operation to be added or the operation whose operand is to be changed is disposed in each cycle in the range of the cycles, outputting an estimation of the change amount in the register transfer level structure.

19. The computer-readable recording medium according to claim 16, wherein the register transfer level structure change amount estimating and outputting operation comprises:
when an operation order of the behavioral description and the register transfer level description is changed in a change part in the behavioral description, outputting scheduling change information for canceling the change in the operation order; and
estimating and outputting the change amount in the register transfer level structure based on the scheduling change information.

20. The computer-readable recording medium according to claim 16, wherein the computer program makes the computer create the control data flow graph, the binding information, and the register transfer level description from the behavioral description.
